(19) United States
(12) Patent Application Publication
(10) Pub. No.: US 2010/0055254 A1
(43) Pub. Date: Mar. 4, 2010

(54) Beverage Brick and the Method Thereof

(76) Inventor: Mary D. Hu, El Monte, CA (US)

Correspondence Address: DAVID AND RAYMOND PATENT FIRM, 108 N. YNEZ AVE., SUITE 128, MONTEREY PARK, CA, 91754, US

(21) Appl. No.: 12/313,177

(22) Filed: Nov. 17, 2008

Related U.S. Application Data
(60) Provisional application No. 61/190,708, filed on Aug. 31, 2008.

(51) Int. Cl. A23L 1/22; A23P 1/04; A23F 5/24; A23G 1/54

(52) U.S. Cl. 426/96; 426/89; 426/103; 426/285

(57) ABSTRACT

The beverage brick includes a brick body and a soluble beverage ingredient. The brick body has a core portion and a shell portion enclosing the core portion. The soluble beverage ingredient includes a flavor ingredient is formed at the core portion and an essential ingredient is formed at the shell portion, wherein the flavor and essential portion are pre-set in a predetermined proportion, so that the beverage brick is dissolved into water to form a beverage product. Therefore, all essential ingredient and flavor ingredient are formed in a single solid brick unit for enhancing the preparation of the beverage product by simply dissolving the solid brick unit into water.

### CROSS-REFERENCE TO RELATED APPLICATION

This is a non-provisional application of a provisional application having an application No. 61/190,708 and a filing date of Aug. 31, 2008.

### BACKGROUND OF THE PRESENT INVENTION

1. Field of Invention

The present invention relates to an instant beverage, and more particularly to a beverage brick which provides all essential ingredient and flavor ingredient in a single solid brick unit for enhancing the preparation of the beverage product by simply dissolving the solid brick unit into water.

2. Description of Related Arts

Instant beverages, such as instant coffee, are considered one of popular beverage products for the purpose of providing the daily drinks for people. The major advantage of instant coffee is its simplicity of preparation instead of brewing the coffee. Generally speaking, the instant coffee is formed in powder or granulated form and is contained in a container, wherein the drinker is able to dissolve the instant coffee powder in hot water and mix with sugar and cream powder. Even though the instant coffee powder is provided to simplify the preparation of coffee in comparison with other forms of coffee, the drinker must carry three different containers for instant coffee powder, sugar, and cream powder respectively. It is appreciated that the drinkers may wait in line for the preparation of instant coffee because they must add each of the ingredients at one time into the cup. It is always a mess that the powders of instant coffee, sugar, and/or cream dropping on the countertop.

Instant beverages packed in individual packs are already marketed. Through variety of manufacturing process, the row material is dehydrated into the granules or powder form and packed into individual packs. A consumer can conveniently enjoy a drink by opening the individual pack of the beverage and dissolving the powder into hot water. Because the instant beverages are usually packed with flavors such as cream and sugar, there is no need for consumer to prepare other products such as coffee-mate to flavor the drinks.

Take the instant coffee for example, the instant coffee beverage is derived from brewed coffee beans. After serious steps of process, the coffee beans is dehydrated and turned into powder form. The instant coffee packs are added the sugar and cream with a suitable proportions. All the consumer needs to do is to tear open the pack and dissolve the instant coffee powder into hot water. The consumer can enjoy a drink similar to the conventional coffee in few minutes.

In the speed era, the instant beverages such as instant coffee, instant milk tea, instant hot chocolate and the likes are extremely popular since they are speed of preparation. Also, the volume and the weight of the instant beverages are less than the row material such as coffee beans, coco beans, and tea leafs to prepare the same among of a drink. The long shelf life is another advantage of the instant beverages. Furthermore, the instant beverages are not only can be dissolved into hot water, but also dissolved into cold water to prepare a cold drink. Instant beverages are convenient for preparing both hot drinks popular in warmer climate and iced drinks popular in hot seasons.

However, the instant beverages in the market now still have several drawbacks. When the consumer tears the instant beverage packing to open it, the powders are easily sprayed out everywhere by accident. After the instant beverage powders are pulled into hot water, the powders are intended to aggregate to form several lumps, so that the powders is harder to be well mixed. In addition, different ingredient powders have different solubility in water such that some ingredient powders will be dissolved in water faster than the others. In other words, some of the ingredient powders may not be totally dissolved in water.

### SUMMARY OF THE PRESENT INVENTION

A main object of the present invention is to provide a beverage brick, which provides all essential ingredient and flavor ingredient in a single solid brick unit for enhancing the preparation of the beverage product by simply dissolving the solid brick unit into water.

Another object of the present invention is to provide a beverage brick, wherein the essential ingredient and the flavor ingredient are not pre-mixed with each other to enhance the soluble beverage ingredient being dissolved in water. In particularly, the flavor ingredient is formed at the core portion while the essential ingredient is formed at the shell portion to enclose the core portion. Therefore, a user can easily enjoy a flavored drink by simply dissolving the beverage brick into the water.

Another object of the present invention is to provide a method for manufacturing beverage brick to prepare a beverage product after being dissolved in water by simply dissolving the beverage brick into the water.

Another object of the present invention is to provide a beverage brick, wherein the powder of the instant beverage are compacted into a solid brick, so that the user can open the packing of the beverage brick without spray out the powder everywhere to mess up the environment.

Another object of the present invention is to provide a beverage brick, wherein an essential volume formed at the shell portion are greater than a flavor volume formed at the core portion to enable the relatively large amount of essential ingredient at the shell portion enclosing the relatively small amount of flavor ingredient at the core portion.

Another object of the present invention is to provide a beverage brick, which can be formed as an instant coffee brick or instant chocolate drink brick with predetermined proportion of the essential ingredient and the flavor ingredient.

Another object of the present invention is to provide a beverage brick, which can provide a variety of instant coffee, wherein the essential ingredient can be one of decaffe, dark roast, medium roast, and mind roast coffee powder, while the flavor ingredient can be sugar and different flavors creams. The variety of proportion of essential and the flavor parts are provided for sweetened, light sweetened, or unsweetened instant coffee.

Another object of the present invention is to provide a beverage brick, wherein the holding member is provided for retaining the brick body a position while the holding member becomes a stirring rod after the beverage brick dissolved into water.

Accordingly, in order to accomplish the above objects, the present invention provides a beverage brick which comprises a brick body and a soluble beverage ingredient.

The brick body has a core portion and a shell portion enclosing the core portion. The soluble beverage ingredient comprises a flavor ingredient is formed at the core portion and an essential ingredient is formed at the shell portion, wherein the flavor and essential portion are pre-set in a predetermined proportion, so that the beverage brick is dissolved into water to form a flavored drink.

Accordingly, the present invention also provided a method for manufacturing beverage brick comprising the steps of (a) press-making a flavor ingredient to form a solid nucleus, and (b) press-making an essential ingredient to form a solid crust to entirely enclose the nucleus, wherein the nucleus forms a core portion having the flavor ingredient and the crust forms a shell portion having the essential ingredient so as to form a brick body, wherein the flavor and the essential ingredient are formed in a predetermined proportion for being dissolved in water to form a beverage product.

These and other objectives, features, and advantages of the present invention will become apparent from the following detailed description, the accompanying drawings, and the appended claims.

### BRIEF DESCRIPTION OF THE DRAWINGS

FIG. 1 is the perspective view of a beverage brick according to a preferred embodiment of the present invention, illustrating the beverage bricks contained by a container.

FIG. 2 is the sectional view of the beverage brick according to the preferred embodiment of the present invention.

FIG. 3A illustrates a first alternative mode of the beverage brick according to the preferred embodiment of the present invention.

FIG. 3B illustrates a second alternative mode of the beverage brick according to the preferred embodiment of the present invention.

FIG. 4 illustrates a third alternative mode of the beverage brick according to the preferred embodiment of the present invention, the brick body being retained by a holding member.

### DETAILED DESCRIPTION OF THE PREFERRED EMBODIMENT

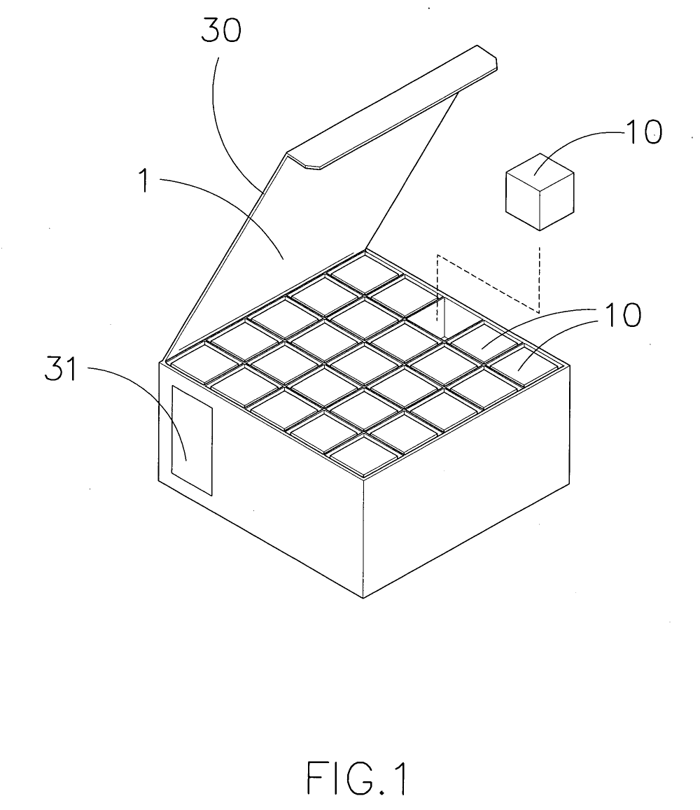

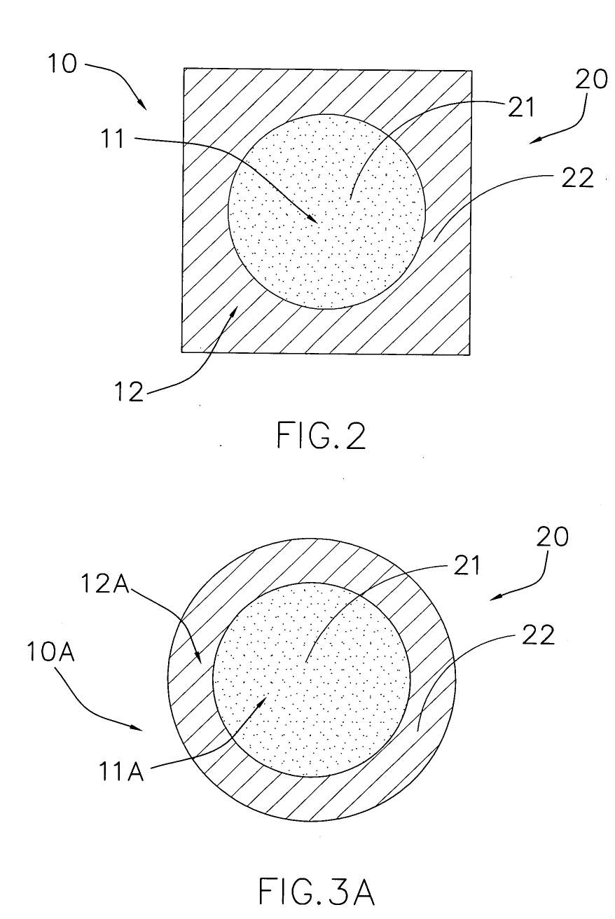

Referring to FIGS. 1 and 2 of the drawings, a beverage brick according to a preferred embodiment of the present invention is illustrated, wherein the beverage brick comprises a brick body 10 comprising a core portion 11 and a shell portion 12 entirely enclosing the core portion 11 of the brick body 10.

The beverage brick further comprises a soluble beverage ingredient 20 which comprises an essential ingredient 22 formed at the shell portion 12 of the brick body 10 and a flavor ingredient 21 formed at the core portion 11 of the brick body 10, wherein the essential ingredient 22 and the flavor ingredient 21 are pre-set in a predetermined proportion for being dissolved in water to form a beverage product.

In other words, the ratio of the flavor ingredient 21 and the essential ingredient 22 are pre-set to a predetermined proportion, so that the beverage product can be easily prepared by dissolving the beverage brick in water. Therefore, the user is able to quickly enjoy the beverage product having the similar taste of a conventional beverage without an additional preparation for adding the flavors.

As shown in FIGS. 1 and 2, each of the brick bodies 10 has a cube shape that the brick bodies 10 can be packed in a compact manner. Accordingly, the beverage brick further comprises a container 30, wherein one or more brick bodies 10 can be packed and contained in the container 30 such that the user can easily take out one brick body 10 from the container 30 without messing up the environment unintentionally.

As shown in FIG. 2, the flavor ingredient 21 is formed as a solid nucleus of the brick body 10 wherein the solid nucleus of the flavor ingredient 21 is formed in spherical shape. The essential ingredient 22 is formed as a solid crust entirely enclosing the flavor ingredient 21 therein, wherein the solid curst of the essential ingredient 22 has a cube shape.

It is appreciated that the brick body 10 can have a plurality of shell portions 11 receiving different essential ingredients 22 and a plurality of core portions 12 receiving different flavor ingredients 21. In other words, the brick body 10 can have a plurality of component layers for different ingredients. In addition, the core portion 11 and the shell portion 12 of the brick body 10 should contain different solubility of the flavor ingredient 21 and the essential ingredient 22 to enhance the soluble beverage ingredient 20 being well-dissolved in water. In other words, the ingredient at the shell portion 12 of the brick body 10 will dissolve in water before the ingredient at the core portion 11 of the brick body 10.

Accordingly, the container 30 is adapted for packing the brick bodies 10, wherein the uniformed brick bodies 10 are substantially packed into the container 30, so that the user can easily take out one of the brick bodies 10 in the container 30. Moreover, an information tag 31 is provided on the container 30 to show the information of the beverage bricks such as flavor, types, producing date, and more detail ingredients of the beverage brick. And if desired, the beverage brick can be individually packed in sealed wrappers or casings so that the individual wrappers can prevent the strength of the beverage flavor been reduced after opened the container 30, such that the strength of the beverage flavor is retained until the individual wrapper or casing is opened for use. As it is mentioned above, the cube shaped brick bodies 10 can be fittingly paced in the rectangular shaped container 30.

According to the preferred embodiment, the volume of the essential ingredient 22 at the shell portion 12 is larger than the volume of the flavored ingredient 21 at the core portion 11 of the brick body 10, so that the essential ingredient 22 has the larger content than the flavor ingredient 21. Even if a particle of the essential ingredient 22 peels off the shell portion 12, the ratio of the essential and flavor ingredients 22, 21 only has slightly changed.

It is appreciated that the beverage brick has variety of flavors and choices such as sweetened, unsweetened, non-fat cream, or Hazelnut cream, so that the user can choose their favorite taste or flavor drinks, and conveniently and quickly prepare the beverage product.

Accordingly, for an instant coffee, the essential ingredient 22 at the shell portion 12 of the brick body 10 is coffee particles and the flavor ingredient 21 of the core portion 11 of the brick body 10 is the mixture of sugar and cream, wherein the coffee particles and the mixture of sugar and cream are produced in a predetermined suitable proportion. In addition, the instant coffee of the beverage brick provides variety of selections for the user to choose their favorite flavor and type, wherein the coffee particles has decafe, dark roast, medium roast, mind roast coffee powders and/or other different type of coffee such as American coffee, Italian coffee and the likes, wherein the mixture of the flavor ingredient 21 has the choices of sweetened, unsweetened, Hazelnut flavor, Vanilla flavor and the likes. Thus, an instant coffee drink tasted similar to the conventional coffee drink is formed by just dissolving the beverage brick in water.

Alternatively, for an instant chocolate, the essential ingredient 22 at the shell portion 12 of the brick body 10 is chocolate particles and the flavor ingredient 21 of the core portion 11 of the brick body 10 is mainly the mixture of sugar and cream, wherein the coffee particles and the mixture of sugar and cream are produced in a predetermined suitable proportion. The instant chocolate of the beverage brick provides variety of selections for the user to choose their favorite flavor and type, wherein the beverage brick of the instant chocolate has dark chocolate, milk chocolate, different percentage dark chocolate, sweetened, unsweetened, non-fat, low fat and the likes. Thus, an instant chocolate drink tasted similar to the conventional chocolate drink is formed by just dissolving the beverage brick in water.

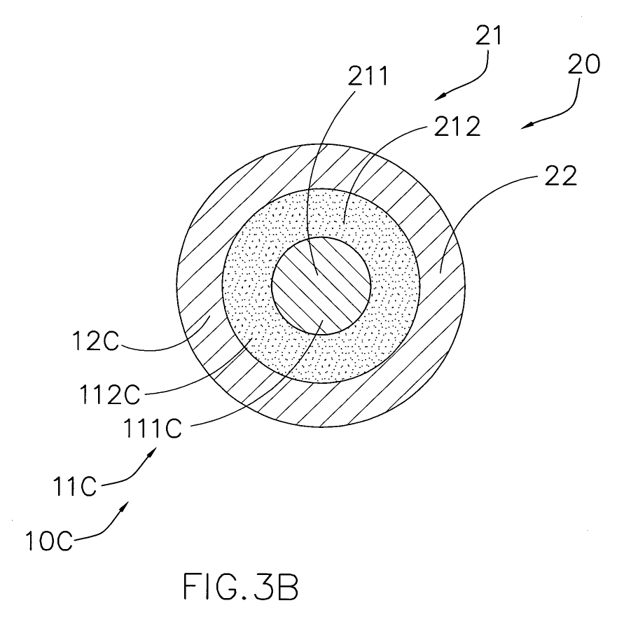

Referring to FIG. 3A of the drawings, a first alternative mode of the brick body 10A of the preferred embodiment of the present invention is illustrated, wherein the brick body 10A has a core portion 11A and a shell portion 12A entirely enclosing the core portion 11A of the brick body 10A.

The essential ingredient 22 of the soluble beverage ingredient 20 is formed at the shell portion 12A of the brick body 10A and the flavor ingredient 21 is formed at the core portion 11A of the brick body 10A.

Accordingly, the brick body 10A has a spherical shape, so that the brick body 10A of the beverage brick has a relatively larger surface area to speed up the dissolving rate of the beverage brick, such that the beverage brick is relatively faster to dissolve in water to prepare a well-mixed drink product.

As shown in FIG. 3A, the flavor ingredient 21 is formed as a solid nucleus of the brick body 10A wherein the solid nucleus of the flavor ingredient 21 is formed in spherical shape. The essential ingredient 22 is formed as a solid crust of the brick body 10A entirely enclosing the flavor ingredient 21 therein, wherein the solid curst of the essential ingredient 22 also has a spherical shape.

Referring to FIG. 3B of the drawings, a second alternative mode of the brick body 10C of the preferred embodiment of the present invention is illustrated, wherein the brick body 10C has a core portion 11C and a shell portion 12C entirely enclosing the core portion 11C of the brick body 10C.

The core portion 11C of the brick body 10C further has an inner core portion 111C and an outer core portion 11 2C wherein the inner core portion 111C is entirely enclosed within the outer core portion 112C. Both the inner and outer core portions 111C, 112C of the brick body 10C are in spherical shape.

Accordingly, the brick body 10C has a spherical shape, so that the brick body 10C of the beverage brick has a relatively larger surface area to speed up the dissolving rate of the beverage brick, such that the beverage brick is relatively faster to dissolve in water to prepare a well-mixed drink product.

As shown in FIG. 3B, the flavor ingredient 21 is formed as a solid nucleus of the brick body 10C wherein the solid nucleus of the flavor ingredient 21 is formed in spherical shape. The essential ingredient 22 is formed as a solid crust of the brick body 10C entirely enclosing the flavor ingredient 21 therein, wherein the solid curst of the essential ingredient 22 also has a spherical shape.

The essential ingredient 22 of the soluble beverage ingredient 20 is formed at the shell portion 12C of the brick body 10C and the flavor ingredient 21 is formed at the core portion 11C of the brick body 10C.

Accordingly, the flavor ingredient 21 comprises a first flavor ingredient 211 formed at the inner core portion 111C of the brick body 10C and a second flavor ingredient 212 formed at the outer core portion 112C of the brick body 10C. Preferably, the first and second flavor ingredient 211, 212 are cream powder and sugar respectively. The essential ingredient 22 is preferably coffee particles.

It is appreciated that the shell portion 12C may also have an inner shell portion and an outer shell portion wherein the inner shell portion is entirely enclosed within the outer shell portion. Different essential ingredients can be received in the inner shell portion and the outer shell portion respectively.

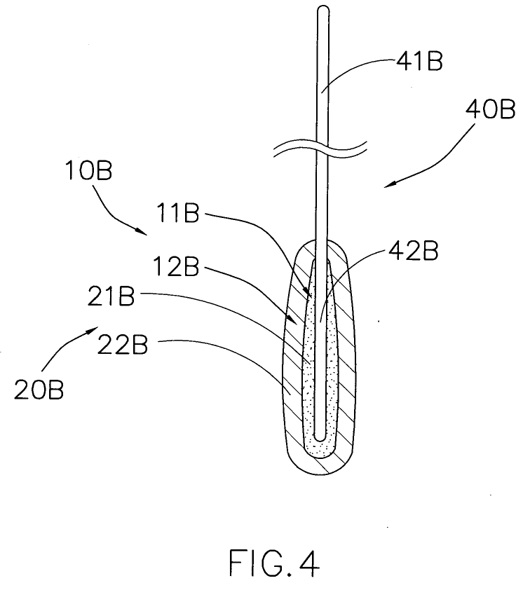

FIG. 4 illustrates another alternative mode of the beverage brick, wherein the beverage brick comprises a brick body 10B comprising a core portion 11B and a shell portion 12B entirely enclosing the core portion 11B of the brick body 10B.

The beverage brick further comprises a soluble beverage ingredient 20B which comprises an essential ingredient 22B formed at the shell portion 12B of the brick body 10B and a flavor ingredient 21B formed at the core portion 11B of the brick body 10B, wherein the essential ingredient 22B and the flavor ingredient 21B are pre-set in a predetermined proportion for being dissolved in water to form a beverage product.

As shown in FIG. 4, the flavor ingredient 21B is formed as a solid nucleus of the brick body 10B while the essential ingredient 22B is formed as a solid crust of the brick body 10B entirely enclosing the flavor ingredient 21B therein. As it is mentioned above, the flavor ingredient 21B is the ingredient such as sugar, cream, variety flavors of syrup ant the likes for flavoring the beverage product, wherein the essential ingredient 22B has the main ingredient of the beverage product such as coffee particles, chocolate particles, green tea particles or the likes. The flavor and the essential ingredients 21B, 22B have a certain ratio which is pre-set in a predetermined proportion of the flavor and essential content, so that the beverage product can be quickly and conveniently prepared by dissolving the brick body 10B without an additional preparation for adding flavors.

The beverage brick further comprises an elongated holding member 40B for retaining the brick body 10B in position. As shown in FIG. 4, the holding member 40B has a handle end portion 41B and an opposed holding end portion 42B penetrating through the brick body 10B to retain the brick body 10B in position in such a manner that the holding member 40B forms a stirring stick after the soluble beverage ingredient 20B is dissolved in water.

In particularly, the holding end portion 42B of the holding member 40B is encircled by the core portion 11B of the brick body 10B while the core portion 11B of the brick body 10B is enclosed by the shell portion 12B of the brick body 10B.

The handle end portion 41B of the holding member 40B is adapted for the user to hold the holding member 40B in position such that the user does not need to directly contact with the brick body 10B by hand for hygiene purpose. The holding member 40B forms as a stirring stick when the brick body 10B dissolved in water to form the beverage product, wherein the holding member 40B is also adapted for accelerating the dissolving rate to form a well-mixed beverage.

In order to manufacturing the beverage brick, the present invention further provides a manufacturing method which comprises the following steps.

(1) Press-make the flavor ingredient 21 to form a solid nucleus.

(2) Press-make the essential ingredient 22 to form a solid crust, wherein the solid nucleus forms the core portion 11 of the brick body 10 while the solid crust forms the shell portion 12 of the brick body 10 to enclose the core portion 11 thereof.

Accordingly, in the step (1), the flavor ingredient 21 is compressed to form a predetermined shape, such as spherical shape, via a compressing machine. In the step (2), the essential ingredient 22 is also compressed to form a predetermined shape, such as a cube shape or a spherical as shown in FIGS. 2 and 3, to enclose the flavor ingredient 21 within the essential ingredient 22.

In order to manufacture the brick body 10B with the holding member 40B as shown in FIG. 4, the flavor ingredient 21B is firstly compressed to encircle around the holding end portion 42B of the holding member 40B in the step (1). Then, the essential ingredient 22 is also compressed to enclose the flavor ingredient 21B at the holding end portion 42B of the holding member 40B.

A step of packing is further provided for wrapping the beverage bricks in a convenient way to open and preserve in the container 30. And if desired, the beverage brick for instant drink can be individually packed in sealed wrappers or casings so that the individual wrappers can prevent the strength of the beverage flavor been reduced after opened the container, such that the strength of the beverage flavor is retained until the individual wrapper or casing is opened for use.

It is worth to mention that, the variety of flavors or types of the beverage bricks can be packed in one container, wherein the variety of the beverage bricks information such as flavors are printed on the individual wrappers or casings as the individual container 30 for the user to conveniently to choose a flavor as they desired, so that the consumer has more choices while they bought one package of the container.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A beverage brick, comprising:
one or more brick bodies, each of which having a core portion and a shell portion enclosing said core portion;
a soluble beverage ingredient which comprises an essential ingredient formed at said shell portion of said brick body and a flavor ingredient formed at said core portion of said brick body, wherein said essential ingredient and said flavor ingredient are pre-set in a predetermined proportion for being dissolved in water to form a beverage product.

2. The beverage brick, as recited in claim 1, wherein said flavor ingredient is formed as a solid nucleus of said brick body while said essential ingredient is formed as a solid crust entirely enclosing said flavor ingredient therein.

3. The beverage brick, as recited in claim 1, wherein a volume of said shell portion of said brick body is larger than a volume of said core portion thereof to enable a relatively small amount of said flavor ingredient being enclosed within a relatively large amount of said essential ingredient.

4. The beverage brick, as recited in claim 2, wherein a volume of said shell portion of said brick body is larger than a volume of said core portion thereof to enable a relatively small amount of said flavor ingredient being enclosed within a relatively large amount of said essential ingredient.

5. The beverage brick, as recited in claim 1, wherein said essential ingredient is coffee particles while said flavor ingredient comprises a mixture of sugar and cream powder, such that soluble beverage ingredient is adapted for being dissolved in water to prepare instant coffee.

6. The beverage brick, as recited in claim 4, wherein said essential ingredient is coffee particles while said flavor ingredient comprises a mixture of sugar and cream powder, such that soluble beverage ingredient is adapted for being dissolved in water to prepare instant coffee.

7. The beverage brick, as recited in claim 1, wherein said essential ingredient is chocolate particles while said flavor ingredient comprises a mixture of sugar and cream powder, such that soluble beverage ingredient is adapted for being dissolved in water to prepare instant chocolate.

8. The beverage brick, as recited in claim 4, wherein said essential ingredient is chocolate particles while said flavor ingredient comprises a mixture of sugar and cream powder, such that soluble beverage ingredient is adapted for being dissolved in water to prepare instant chocolate.

9. The beverage brick, as recited in claim 1, further comprising an elongated holding member having a handle end portion and an opposed holding end portion penetrating through said brick body to retain said brick body in position in such a manner that said holding member forms a stirring stick after said soluble beverage ingredient is dissolved in water.

10. The beverage brick, as recited in claim 6, further comprising an elongated holding member having a handle end portion and an opposed holding end portion penetrating through said brick body to retain said brick body in position in such a manner that said holding member forms a stirring stick after said soluble beverage ingredient is dissolved in water.

11. The beverage brick, as recited in claim 8, further comprising an elongated holding member having a handle end portion and an opposed holding end portion penetrating through said brick body to retain said brick body in position in such a manner that said holding member forms a stirring stick after said soluble beverage ingredient is dissolved in water.

12. The beverage brick, as recited in claim 1, further comprising a container, wherein said brick body is packed and contained in said container.

13. The beverage brick, as recited in claim 8, further comprising a container, wherein said brick body is packed and contained in said container.

14. The beverage brick, as recited in claim 1, wherein said core portion of said brick body further has an inner core portion and an outer core portion, wherein said inner core portion is entirely enclosed within said outer core portion, wherein said flavor ingredient comprises a first flavor ingredient formed at said inner core portion of said brick body and a second flavor ingredient formed at said outer core portion of said brick body.

15. A method for manufacturing beverage brick to form a beverage product after being dissolved in water, comprising the steps of:
(a) press-making a flavor ingredient to form a solid nucleus; and
(b) press-making an essential ingredient to form a solid crust for entirely enclosing said flavor ingredient therein, so as to form a brick body, wherein said flavor ingredient forms a core portion of said brick body while said essential ingredient forms a shell portion of said brick body, wherein said essential ingredient and said flavor ingredient are pre-set in a predetermined proportion for being dissolved in water to form said beverage product.

16. The method, as recited in claim 15, wherein a volume of said shell portion of said brick body is larger than a volume of said core portion thereof to enable a relatively small amount of said flavor ingredient being enclosed within a relatively large amount of said essential ingredient.

17. The method, as recited in claim 16, wherein said essential ingredient is coffee particles while said flavor ingredient comprises a mixture of sugar and cream powder, such that soluble beverage ingredient is adapted for being dissolved in water to prepare instant coffee.

18. The method, as recited in claim 16, wherein said essential ingredient is chocolate particles while said flavor ingredient comprises a mixture of sugar and cream powder, such that soluble beverage ingredient is adapted for being dissolved in water to prepare instant chocolate.

19. The method, as recited in claim 15, further comprising a step of forming said brick body around a holding end portion of an elongated holding member to retain said brick body in position, wherein said holding member forms a stirring stick after said soluble beverage ingredient is dissolved in water.

20. The method, as recited in claim 16, further comprising a step of forming said brick body around a holding end portion of an elongated holding member to retain said brick body in position, wherein said holding member forms a stirring stick after said soluble beverage ingredient is dissolved in water.
